(19) United States
(12) Patent Application Publication
(10) Pub. No.: US 2024/0086852 A1
(43) Pub. Date: Mar. 14, 2024

(54) SYSTEM AND METHOD FOR EMPLOYMENT VERIFICATION

(71) Applicant: Capital One Services, LLC, McLean, VA (US)

(72) Inventors: Louis Buell, Chevy Chase, MD (US); Joshua Edwards, Philadelphia, PA (US); Michael Mossoba, Great Falls, VA (US)

(21) Appl. No.: 17/944,495

(22) Filed: Sep. 14, 2022

(51) Int. Cl. G06Q 10/10; G06Q 10/06; G06Q 40/02

(52) U.S. Cl. CPC G06Q 10/1053; G06Q 10/063114; G06Q 10/0639; G06Q 10/1093; G06Q 40/02

(57) ABSTRACT

Techniques for verifying employment of a user are provided. A financial product or service may be requested by a user. Work schedule information for the user may be determined that may identify an expected work location of the user and expected work times for the user. Location data associated with the user may be obtained and compared to the expected work location and times for the user. A confidence score of the user may be generated based on the comparison. The requested financial product or service may be provided to the user if the confidence score meets or exceeds a predetermined threshold. In this manner, employment and/or reliability may be determined for a user having no credit history.

### FIELD OF USE

Aspects of the disclosure generally relate to tracking a location of a user and more specifically to techniques for using Global Positioning System (GPS) data associated with a portable electronic device to verify that the user is located at a work location of an employer during the user's workday.

### BACKGROUND

Conventional techniques for verifying that a user is located at an employer's work location during the user's workday are unreliable and do not account for the type of work performed by the user.

Aspects described herein may address these and other problems, and generally improve the accuracy of tracking a user's location to verify the user's employment.

### SUMMARY

The following presents a simplified summary of various features described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

The present disclosure describes techniques for using Global Positioning System (GPS) data associated with a portable electronic device of a user to track a location of the user. The GPS data may be used to estimate the location of the user during the user's workday for an employer. The estimated location of the user may be compared to an expected work location of the user and to an expected work schedule of the user. The expected work location of the user and the expected work schedule of the user may be determined based on processing employment-related on-boarding materials associated with the employer. Comparing the estimated location of the user to the expected work location of the user and to the expected work schedule of the user enables verification that the user is working for employer. The expected work location and the expected work schedule of the user may account for the type of work performed by the user including whether the user the user is expected to work remotely, whether the user is expected to travel during the workday (e.g., as a delivery driver), or whether the user is expected to be located at a specific location associated with the employer during the workday (e.g., as an office worker or a factory worker).

Accordingly, the present disclosure describes techniques for verifying an employment of a user. The techniques for verifying employment described herein enable a reliability of the user to be determined, as an indication as to whether the user is likely to maintain employment. The user's employment and/or reliability may be used to determine a creditworthiness of the user to ultimately determine whether to provide a certain financial product or service to the user. Employment and/or reliability of the user may be determined based on location data of the user as provided by a user computing device associated with the user. The location data of the user computing device may serve as a proxy for the location of the user. The location data may be compared to an expected work location of the user and an expected work schedule of the user to determine if the user is indeed showing up to work and working all day as expected. A confidence score for the user may be generated based on comparing the location data to the expected work location and the expected work schedule of the user. At the end of an evaluation period, if the confidence score meets or exceeds a predetermined threshold, then a particular financial product or service requested by the user (e.g., an increase in a credit limit) may be authorized.

These features, along with many others, are discussed in greater detail below.

### BRIEF DESCRIPTION OF THE DRAWINGS

The present disclosure is described by way of example and not limited in the accompanying figures in which like reference numerals indicate similar elements and in which:

FIG. 1 shows an example of a system in which one or more features described herein may be implemented;

FIG. 2 shows an example computing device;

FIG. 3 shows an example employment agreement for a user; and

FIG. 4 shows an example of a process for determining whether to authorize providing a financial product or service to a user.

### DETAILED DESCRIPTION

In the following description, reference is made to the accompanying drawings, which form a part hereof, and in which are shown various examples of features of the disclosure and/or of how the disclosure may be practiced. It is to be understood that other features may be utilized and structural and functional modifications may be made without departing from the scope of the present disclosure. The disclosure may be practiced or carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, features discussed herein may relate to methods, devices, systems, and/or instructions stored on non-transitory computer-readable media for verifying an employment of a user to determine if a particular financial product or service requested by the user should be granted or denied.

Often, a credit history of a user is used to assess a financial risk associated with the user. The user's credit history may be consulted to determine whether or not to provide certain financial products or services to the user. For example, a user's credit history may be consulted to determine if a requested auto loan should be provided to the user.

Many individuals, however, do not have a credit history. Such individuals may be considered to be “credit invisible” as no credit history or record may exist for the user (e.g., with one or more U.S. credit bureaus). A user with no credit history may be required to provide proof of gainful employment to enable a financial institution to determine a creditworthiness of the user. Proof of gainful employment is often shown by the user providing a paycheck to the financial institution. This requirement, however, may be inconvenient as there may be significant delay between a user starting a job and the user receiving a first paycheck. Further, many financial institutions often require multiple paycheck to assess the creditworthiness of the user. If the user is paid bi-weekly or monthly, this delay may be overly burdensome to the user. Accordingly, techniques described herein improve the speed and reliability of verifying employment of a user.

As an example, a first computing device may receive a request associated with a user. The request may relate to a financial account of the user. The request may relate to a financial request for a particular financial product or service (e.g., a car loan or a credit with a particular credit limit). The first computing device may receive employment information for the user. The employment information may include a name of an employer, a job title of the user, and/or a location of the employer. The first computing device may receive work schedule information for the user. The work schedule information may indicate each day the user is scheduled to work for the employer along with a timeframe the user is scheduled to work for the employer for each day the user is scheduled to work for the employer. The first computing device may receive, from a user computing device associated with the user, location data that indicates a current location of the user. The first computing device may compare the location data to the work schedule information for the user. Comparing the location data to the work schedule information for the user may allow the first computing device to determine if the user is employed as the user may allege. Comparing the location data to the work schedule information for the user may allow the first computing device to determine if the user is a reliable worker by determining if the user is indeed showing up to work on time at an expected work location and if the user is staying at work for an entire workday. Based on comparing the location data to the work schedule information for the user, the first computing device may generate a confidence score for the user. The confidence score may indicate a likelihood the user is employed by the employer and/or may indicate a likelihood that the user remains employed (for some period of time). The first computing device may compare the confidence score for the user to a predetermined threshold. The predetermined threshold may be set based on a value associated with the financial product or service requested by the user. The first computing device may determine, based on the confidence score of the user meeting or exceeding the predetermined threshold, to authorize providing the user with the requested financial product or service.

The techniques described herein therefore provide improved techniques for verifying an employment of a user, thereby allowing a financial institution to assess a financial risk or creditworthiness associated with a user that does not have a credit history. Employment verification may be provided in a robust and efficient manner that does not burden the user while reducing an amount of time needed to determine whether or not to authorize providing a requested financial product or service to the user.

Having introduced exemplary features, discussion will now turn to a system that may implement the exemplary features and, in particular, to a system for verifying employment.

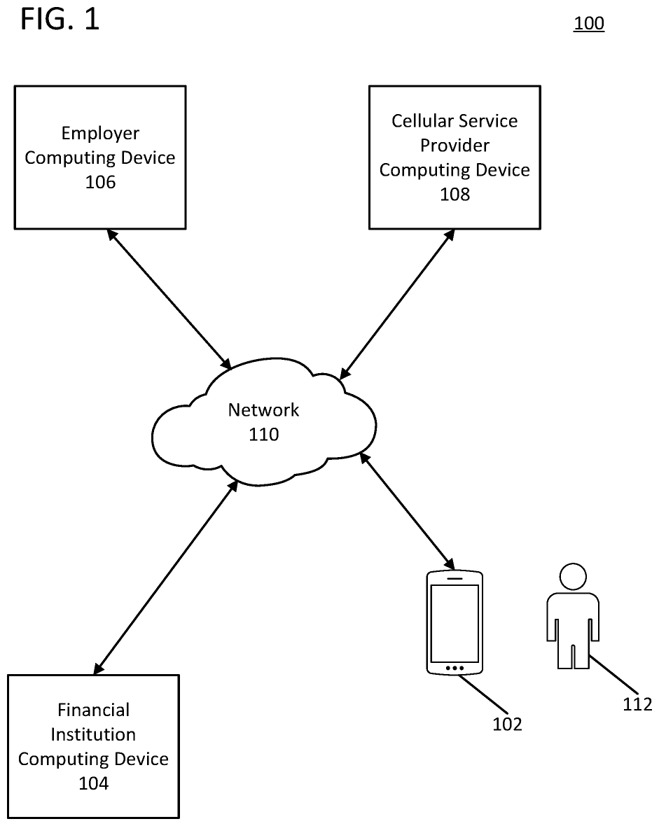

FIG. 1 illustrates a system 100 for providing employment verification according to one or more aspects of the disclosure. The system 100 may include a first computing device 102 (e.g., a user computing device), a second computing device 104 (e.g., a financial institution computing device), a third computing device 106 (e.g., an employer computing device), a fourth computing device 108 (e.g., a cellular service provider computing device), and a network 110.

The first computing device 102 may be any type of computing device, including a mobile or a portable device. For example, the first computing device 102 may be a smartphone, a laptop, a tablet, a desktop, or an equivalent thereof. The first computing device 102 may be a wireless user computing device. The first computing device 102 may be associated with a user 112 that may operate the first computing device. The first computing device 102 may be considered to be a user computing device.

The second computing device 104 may be any type of computing device. The second computing device 104 may be associated with a financial institution. For example, the second computing device 104 may be a server associated with a particular financial institution. The second computing device 104 may represent one or more computing devices and/or a computer network associated with the financial institution. The second computing device 104 may include one or more computers, servers, and/or databases. The financial institution may be a bank, a credit union, a credit card company, or any other type of financial institution that may provide one or more financial accounts, products, and/or services to an individual or other entity. The second computing device 104 may be considered to be a financial institution computing device.

The third computing device 106 may be any type of computing device. The third computing device 106 may be associated with an employer. For example, the third computing device 106 may be a server associated with a particular employer. The third computing device 106 may represent one or more computing devices and/or a computer network associated with the employer. The third computing device 106 may include one or more computers, servers, and/or databases. The employer may be any business, merchant, or other legal entity that employs one or more employees. The third computing device 106 may be considered to be an employer computing device. The third computing device 106 may store and/or provide information regarding an employer.

The fourth computing device 108 may be any type of computing device. The fourth computing device 108 may be associated with a cellular service provider. For example, the fourth computing device 108 may be a server associated with a particular cellular service provider. The fourth computing device 108 may represent one or more computing devices and/or a computer network associated with the cellular service provider. The fourth computing device 108 may include one or more computers, servers, and/or databases. The cellular service provider may be associated with the first computing device 102 and/or the user 112. The cellular service provider may provide cellular service to the first computing device 102 and/or the user 112 may have a cellular account or other cellular service relationship with the cellular service provider. The fourth computing device 108 may be considered to be cellular service provider computing device. The fourth computing device 108 may store and/or provide information relating to the cellular service provided to the first computing device 102. For example, the fourth computing device 104 may store location data or information of the first computing device 102. Location data may be determined based on the first computing device 102 operating on one or more networks (e.g., a cellular network and/or a Wi-Fi network) and/or may be determined based on the first computing device 102 collecting and/or reporting Global Positioning System (GPS) data to the fourth computing device 108.

The network 110 may be any type of communications and/or computer network. The network 110 may include any type of communication mediums and/or may be based on any type of communication standards or protocols. The network 110 communicatively couples the first computing device 102, the second computing device 104, the third computing device 106, and the fourth computing device 108, to enable data and/or other information to be shared between the first computing device 102, the second computing device 104, the third computing device 106, and the fourth computing device 108.

The second computing device 104 may receive a request associated with the user 112. The request may be initiated and/or sent by the first computing device 102, the third computing device 106, or the fourth computing device 108. The request may be associated with any type of financial request. The request may be a request associated with a financial account of the user 112. The financial account may be an existing account or may be an account the user 112 wishes to establish. The request may be a request for a loan (e.g., a car loan), a request for a credit card, a request to open a financial account (e.g., a checking account), a request to increase a credit limit (e.g., a credit limit of a credit card), and/or a request for a cash advance.

The second computing device 102 may determine that the user 112 associated with the request does not have a credit history and/or does not have a credit history sufficient to process the request associated with the user 112. For example, the user 112 may be newly associated with an area, jurisdiction, or country and may not be associated with any credit history file or records maintained by one or more credit institutions, agencies, or bureaus (e.g., one or more U.S. credit agencies). Typically, the second computing device 102 may consult a credit history of an individual to determine whether or not to authorize a financial request associated with the individual. For example, a credit card company may consult a credit history report of an individual that requests to have his credit limit of a credit card increased, to judge a creditworthiness of the individual. Based on the credit history of the individual, the request to increase the credit limit may be authorized or not authorized (e.g., denied or a lower increase may be authorized). According to one or more aspects of the disclosure, the user 112 may not be associated with any credit history, report, or other information to judge or assess a creditworthiness of the user 112. As such, the second computing device 104 may implement and/or rely on other techniques as described herein to determine whether or not to fulfill the financial request associated with the user 112.

The second computing device 104 may receive data or other information related to an employment of the user 112. The data or other information related to the employment of the user 112 may be provided by the third computing device 106, the first computing device 102, and/or the user 112. The user 112 may provide information related to the employment of the user 112 by entering data via the first computing device 102 (e.g., via an app operating on the first computing device 102) and causing the data to be received by the second computing device 104. Any information related to the employment of the user 112 may be confirmed and/or supplemented by one or more documents indicating information related to the employment of the user 112.

For example, the second computing device 102 may receive an employment agreement associated with the user 112. The user 112 may cause the first computing device 102 to upload a copy or image of the employment agreement to the second computing device 104. The user 112 may cause (e.g., may authorize) the third computing device 103 to provide a copy of the employment agreement to the second computing device 102. Under any scenario, the second computing device 104 may use the employment agreement to determine employment information for the user 112 and/or to verify and/or confirm any employment information for the user 112 obtained by any other manner (e.g., to verify any employment information directly provided by the user 112).

Alternatively, or in addition thereto, onboarding documents relating to the employment of the user 112 may be provided to the second computing device 104. Onboarding documents may include information associated with the employer (e.g., a name of the employer, an address of the employer, etc.) and/or information associated with the user 112 (e.g., an address of the user 112, an age of the user 112, a Social Security number of the user 112). In the discussion herein, references to an employment agreement may include any documentation related to an employment or job of the user 112 (e.g., any onboarding documents, paperwork filled out by the employer or user 112, etc.).

The second computing device 104 may process the employment agreement using one or more natural language processing techniques or algorithms and/or using optical character recognition techniques or algorithms to read or otherwise extract information provided by the employment agreement (and/or any onboarding document). The second computing device 104 may determine, from processing the employment agreement, various information related to employment of the user 112 such as, for example, a name of an employer of the user 112, a job title of the user 112, a type of job of the user 112, a description of the duties of the user 112, a salary of the user 112, and/or a location of the employer of the user 112.

The second computing device 104 may identify the employer of the user 112 (or an alleged employer of the user 112) based on processing the employment agreement of the user 112. The second computing device 104 may verify the employer identified by processing the employment agreement of the user 112. The second computing device 104 may attempt to verify any information related to the employer (and/or the employment of the user 112 with the employer) based on any publicly available information. The second computing device 102 may implement and/or use one or more web crawler algorithms to collect information (e.g., public information) associated with the identified employer. For example, the second computing device 104 may use a web crawler algorithm to locate a website provided by the third computing device 106. The website may provide information regarding the identified employer including, for example, the name of the employer, the type of employer, a type of product and/or service provided by the employer, a location or address of the employer, and/or recent job positions or filled job openings of the employer. Information related to the employer may be provided or stored on other computing devices including one or more third party computing devices that are not owned or controlled by the employer.

The second computing device 104 may also implement one or more algorithms to search social networks (e.g., a social network platform) and/or social media posts to collect or ascertain information relating to the identified employer. In general, any public information that may be collected by the second computing device 104 via the Internet, the WWW, or any social network may be used to validate any aspect of the employer or the employment of the user 112. In doing so, the second computing device 104 may increase a likelihood of detecting any false or misleading information related to the employment of the user 112.

For example, the user 112 may cause the first computing device 102 to provide, via an app operating on the first computing device 102, information related to an employment of the user 112 (e.g., a name and address of an employer of the user 112) to the second computing device 104. The user 112 may cause the first computing device 102 to transmit a copy of an employment agreement to the second computing device 104. The second computing device 104 may process the information from the user 112 and/or may process the employment agreement to determine that the user 112 allegedly works for “Bob's Big Box Store” located at “121 Rivertop Cir.” The second computing device 104 may use one or more web crawler algorithms or may otherwise search for public information related to Bob's Big Box Store provided by any website (e.g., a website for Bob's Big Box Store maintained by the third computing device 106) or any social network (or any social media post) that may be used to verify or validate the existence and/or authenticity of the employer and the location of the employer (i.e., Bob's Big Box Store located at 121 Rivertop Cir.).

Verification of the alleged employer or the user 112 may be a factor used to determine whether or not to fulfill the financial request for the user 112. For example, if the user 112 alleges that he is employed at “Ralph's Big Box Store” at a certain location but the second computing device 104 is unable to collect any public information associated with Ralph's Big Box Store or the alleged location, then the second computing device 104 may determine not to fulfill the financial request from the user 112 (e.g., because the second computing device 104 may determine that the alleged employer Ralph's Big Box Store is not an actual merchant or store, or that no store owned by Ralph's Big Box Store is located at the provided location).

The second computing device 104 may receive data or other information related to a work schedule of the user 112. The data or other information related to the work schedule of the user 112 may be provided by the third computing device 106, the first computing device 102, and/or the user 112. The user 112 may provide information related to the work schedule of the user 112 by entering data via the first computing device 102 (e.g., via an app operating on the first computing device 102) and causing the data to be received by the second computing device 104. Any information related to the work schedule of the user 112 may be confirmed and/or supplemented by one or more documents indicating information related to the work schedule of the user 112.

For example, the second computing device 102 may receive a work schedule associated with the user 112. The user 112 may cause the first computing device 102 to upload a copy or image of the work schedule to the second computing device 104. The user 112 may cause (e.g., may authorize) the third computing device 106 to provide a copy of the work schedule to the second computing device 102. Under any scenario, the second computing device 104 may use the work schedule to determine work schedule information for the user 112 such as, for example, a daily, a weekly, and/or a monthly work schedule for the user 112. The user 112 may provide additional work schedules over time as the work schedule for the user 112 changes.

The second computing device 104 may process the work schedule using one or more natural language processing techniques or algorithms and/or using optical character recognition techniques or algorithms to read or otherwise extract information provided by the work schedule. The second computing device 104 may determine, from processing the work schedule, various information related to a work schedule of the user 112 such as, for example, each day the user 112 is scheduled to work for the employer and/or a timeframe (time range) the user 112 is scheduled to work for the employer for each day the user 112 is scheduled to work for the employer (e.g., the time each day the user 112 is to be working for the employer).

Any document or information providing the work schedule for the user 112 may be a separate document from an employment agreement for the user 112 or may be part of the same document or file (or may be part of any onboarding document provided to the second computing device 104). Accordingly, under certain scenarios, the same document or set of documents may be received and processed by the second computing device 104 to determine employment information for the user 112 and to determine work schedule information for the user 112. Any employment and/or work schedule information for the user 112 as determined or extracted by the second computing device 104 may be verified and/or validated based on public information including, for example, recent job postings for the employer determined from searches of public websites or social media networks as described herein.

A nature, description, or type of a job of the user 112 may be determined based on determined work schedule information and/or determined employment information for the user 112. For example, the second computing device 104 may determine (e.g., based on a job title, a job description, or other information received and processed by the second computing device 104) that the user 112 is an office worker that is expected to work at the employer's office location, that the user 112 is an office worker that will be working from home, or that the user 112 will be a delivery driver that will be driving around a certain geographical location when working for the employer.

The second computing device 104 may determine, judge, and/or assess an authenticity of any document provided by the first computing device 102, the user 112, and/or the third computing device 106 that may be provided as evidence of the employment information and/or work schedule of the user 112. For example, the second computing device 104 may compare any provided document to any document previously provided (e.g., by another user) that relates to the same employer, to determine if the nature of the documents is similar. The second computing device 104 may also search for public information regarding the employer as described herein to determine a type of the employer—for example, to determine if the employer is a grocery store, a law office, or an IT firm.

The second computing device 104 may receive location data associated with the user 112. The location data may be Global Positioning System (GPS) data. The location data may be provided by the first computing device 102. For example, the user 112 may allow and/or otherwise cause the first computing device 102 to send location data (of the first computing device 102 which may serve as a proxy for the location of the user 112) to the second computing device 104. An app or other program operating on the first computing device 104 may enable the first computing device 102 to send location data to the second computing device 104.

The location data may be provided by the fourth computing device 108. For example, the fourth computing device 108 may be a computing device associated with a cellular service provider that provides cellular service to the first computing device 102. The user 112 may have an account or may otherwise receive cellular service from the cellular service provider (e.g., via the first computing device 102) associated with the fourth computing device 108. The fourth computing device 108 may store or may otherwise access records or other information indicating a location of the first computing device 102. The user 112 may authorize the cellular service provider associated with the fourth computing device 108 to provide the location data to the second computing device 102.

Location data of the first computing device 102 may indicate a location of the user 112. The user 112 may allow the second computing device 104 to receive the location data. The second computing device 104 may process the location data in conjunction with the employment information and/or work schedule information for the user 112 to determine if the user 112 is indeed employed (e.g., by the alleged employer) and/or if the user 112 is working on the days and at the times indicated in the work schedule information. In other words, the second computing device 104 may use the location data and any information related to the employment of the user 112 to determine if the user 112 is indeed employed by the employer as alleged by the user 112 and/or to assess whether the user 112 is working as required by the employer. As such, a determination may be made as to whether the user 112 is employed by the employer and a determination may be made as to a reliability of the user 112 (e.g., based on determining if the user 112 is showing up to work on time and staying to work for the entire working day). One or more of these determinations may be made by cross-referencing the location data, the work schedule information for the user 112, and an expected work location for the user 112. The expected work location of the user 112 may be determined based on employment information and/or work schedule information.

For example, a current work schedule of the user 112 may be provided to the second computing device 104. Location data of the first computing device 102 may also be provided to the second computing device 104 for a period of time covered by the current work schedule of the user 112. The second computing device 104 may request the location data at certain times of certain days (e.g., corresponding to times the user 122 is to be working). The second computing device 104 may evaluate a likelihood the user 112 is indeed employed by the employer based on the location data. The second computing device 104 may compare the location data to the work schedule information and/or any other information related to the employment of the user 112 (e.g., an address of the employer, an expected work location of the user 112, etc.) to assess whether the user 112 is showing up and staying at work as specified by the work schedule (and therefore likely gainfully employed)—or is not showing up and staying at work as specified by the work schedule (and therefore likely not gainfully employed, or not likely to remain gainfully employed for long). In this manner, a reliability of the user 112 may also be determined. The employment determination and/or reliability determination for the user 112 may then be used to assess a financial risk associated with the user 122 and/or a creditworthiness of the user 112.

Location data associated with the first computing device 102 (and/or user 112) may be provided to the second computing device 104 at any time. The location data may be provided periodically or randomly. The location data may be provided every few seconds (e.g., every 30 seconds), every few minutes (e.g., every 5 minutes), or occasionally throughout a day (e.g., 10 times over an 8 hour work shift of the user 112). The location data may be provided to the second computing device 104 for any period of time—for example, for a week, two weeks, a month, or two months. The location data may be provided to the second computing device 104 during work hours for the user 112 based on, for example, work schedule information determined for the user 112. In this manner, location data of the user 112 may not be provided to the second computing device 104 when the user 112 is not scheduled to be working, to ensure privacy of the user 112 when not working.

The second computing device 104 may compare the location data to the work schedule information for the user 112, including, for example, an expected work location for the user 112. The second computing device 104 may compare the location data to the work schedule information for the user 112 to determine if the location data is consistent with the job of the user 112. In other words, the second computing device 104 may use the location data and the work schedule information to determine if the user 112 is indeed working on the days and at the times the user 112 is scheduled to be working for the employer. The second computing device 104 may verify that the location data indicates some movement of the first computing device 102 throughout the workday of the user 112. That is, the second computing device 104 may verify that that the location data indicates some movement of the first computing device 102 within an area of close proximity to the expected work location for the user 112. In this manner, the second computing device 104 may detect and flag a situation in which the location data indicates no movement at all of the first computing device 102 thought a workday. No movement at all of the first computing device 102 thought a workday may indicate that the user 112 is attempting to circumvent location tracking by, for example, dropping off the first computing device 102 at a location throughout at day and picking it up later. Accordingly, some movement of the first computing device 102 within an area of close proximity to the expected work location of the user 112 may be expected, tracked, and/or verified.

The second computing device 104 may compare the location data to work schedule information for the user 112 to generate a confidence score for the user 112. The confidence score 112 may indicate a level of confidence that the user is gainful employed (and/or is a reliable worker). The confidence score may indicate a level of confidence that the user 112 will remain gainfully employed based on the location data indicating that the user 112 is working for the employer at the times the user 112 is scheduled to do so.

The second computing device 104 may account for the nature of the employment of the user 112 (e.g., type of job and/or type of job duties) when generating the confidence score. For example, the second computing device 104 may determine the user 112 is an office worker that is required to work at an office location of the employer. The second computing device 104 may compare the office location of the employer to the location data to determine if the user 112 is indeed at the office location of the employer (e.g., the expected work location of the user 112) during the required time each day the user 112 is scheduled to work for the employer.

As another example, the second computing device 104 may determine the user 112 is an office worker that may work remotely (e.g., from home). The second computing device 104 may compare the home address of the user 112 to the location data to determine if the user 112 is indeed at home (e.g., the expected work location of the user 112) during the required time each day the user 112 is scheduled to work for the employer. The second computing device 104 may account for days and/or times of a day when the user 112 may choose to work at an office location of the employer. The second computing device 104 may account for days and/or times of a day when the user 112 may choose to work at a coffee shop (e.g., rather than at home).

As a third example, the second computing device 104 may determine the user 112 is a delivery driver for the employer. The second computing device 104 may compare various routes of the user 112 to the location data to determine if the user 112 is likely driving a delivery vehicle during the required time each day the user 112 is scheduled to work for the employer. The second computing device 104 may account for days and/or times of a day when the user 112 may return to a warehouse of the employer and/or when the location data may not be available due to driving in tunnels or other areas where a cellular signal or other location data may not be available or ascertainable.

In general, the second computing device 104 may account for any and all aspects of the job of the user 112 including the type of job, location (or locations) of the job, and any commute associated with the job to assess whether the user 112 is likely working for the employer as indicated or is not. For example, if the work schedule information for the user 112 indicates the user 112 is to be at an office location of the employer from 9 am to 5 pm, Monday through Friday, and the location data indicates the user was in another state (and not at the office location of the employer), then the second computing device 104 may generate a relatively low confidence score for the user 112. Alternatively, if the location data indicates that the user 112 was indeed at the office location of the employer, then the second computing device may generate a relatively high confidence score for the user 112.

The second computing device 104 may generate and/or adjust a confidence score for the user 112 based on location data provided by similar employed individuals, with similar job titles or descriptions and working for the same or similar employers. For example, the second computing device 104 may use information determined from interactions with other users or based on or more machine learning (ML) algorithms to determine whether location data for the user 112 is consistent with the employment of the user 112.

The confidence score for the user 112 may be generated and/or adjusted. As cross-referencing the location data with the expected location of the user 112 with the work schedule of the user 112 indicates that the user 112 is employed and/or staying at work for a full work day, the confidence score may be increased. In contrast, as cross-referencing the location data with the expected location of the user 112 with the work schedule of the user 112 indicates that the user 112 is not employed and/or is not staying at work for a full work day, the confidence score may be decreased.

As an example, the second computing device 104 may determine each instance when the location data indicates that the user 112 was located at the location of the employer during the timeframe the user 112 is scheduled to work for the employer, for each day the user 112 is scheduled to work for the employer. For each such instance (e.g., indicating that the user 112 was indeed working for the employer and/or working at the expected location during the expected work hours), a confidence score for the user 112 may be increased. Alternatively, the confidence score may be decreased for each instance when the location data indicates that the user 112 was not located at the location of the employer during the timeframe the user 112 is scheduled to work for the employer, for each day the user 112 is scheduled to work for the employer (e.g., indicating the user 112 was not working for the employer and/or that the user 112 was not at the expected work location during the expected work hours).

In this manner, a confidence score of the user 112 may be changed over time. That is, the confidence score may be adjusted over time as more location data is collected for the user 112 and compared to the employment information and/or work schedule information for the user 112. The confidence score may be generated and adjusted over any period of time (e.g., 1 week, 2 weeks, a month, etc.). At the end of some predetermined amount of time (e.g., the tracking period for the user 112), the confidence score of the user 112 may be compared to a predetermined threshold. Work schedule information and/or employment information may be supplemented or updated over time. For example, if the user 112 initially starts employment with an employer by undergoing training at an office location but then is later allowed to work remotely, then work location and/or schedule information for the user 112 may be updated and provided to the first computing device 102.

If the confidence score meets or exceeds the predetermined threshold, then the second computing device may authorize or otherwise fulfill the financial request from the user 112. Alternatively, if the confidence score does not meet or exceed the predetermined threshold, then the second computing device may not authorize or may not otherwise fulfil the financial request from the user 112 (e.g., may deny the financial request).

The predetermined threshold may be set and/or adjusted by the second computing device 104 based on various factors. The predetermined threshold may be set based on a value of the financial request from the user 112. For example, a request for a loan of $10,000.00 may result in a relatively higher predetermined threshold being set compared to a predetermined threshold set for a request for a loan of $1,000.00. The predetermined threshold may be set based on the type of financial request from the user 112. For example, a request to open a basic checking account may result in a relatively lower predetermined threshold being set compared to a predetermined threshold set for a request for an auto loan. The predetermined threshold may be set based on a determined salary or prior history of employment of the user 112. For example, a request may be associated with a relatively lower predetermined threshold when a salary of the user 112 equates to $35/hour while the same request may be associated with a relatively higher predetermined threshold when a salary of the user 112 equates to $15/hour. As another example, a request may be associated with a relatively lower predetermined threshold when the user 112 provides evidence of prior employment while the same request may be associated with a relatively higher predetermined threshold when the user 112 has no employment history.

In various embodiments, the user 112 may provide various employment and work schedule information to the second computing device 104 via an app operating on the first computing device 102. The app may be provided by the second computing device 104 (e.g., by a financial institution associated with the second computing device 104) or by the third computing device 106 (e.g., by an employer associated with the third computing device 106). The app may allow the user 112 to input data (e.g., via a touchscreen of the first computing device 102). The app may provide a Web-based interface for entering data directly and/or for uploading documents or images related to the employment and/or work schedule of the user 112.

An app operating on the first computing device 102 may also allow the second computing device 104 to receive and/or collect location data associated with the first computing device 102 (and by proxy the user 112). The app may be the same app discussed above or may be a different app. The app may be provided the second computing device 104 (e.g., by a financial institution associated with the second computing device 104), by the third computing device 106 (e.g., by an employer associated with the third computing device 106), or by the fourth computing device (e.g., by a cellular server provider associated with the fourth computing device 108). The app may collect location data (e.g., GPS data from the first computing device 102) and may relay the location data to the second computing device 104. The app may allow the first computing device 102 to share location data to the second computing device 104 without relying on or involving the fourth computing device 108. This allows for a more direct relationship between the user 112, the first computing device 102, the second computing device 104, and the financial institution associated with the second computing device 104 to share location information. Location data for the first computing device 102 may be supported by connectivity to a cellular system, a local area network (e.g., a Wi-Fi network), a GPS network, and/or by Near-Field Communications.

In various embodiments, the second computing device 104 may request location data. That is, the second computing device 104 may request location data be sent to the second computing device 102 at certain times rather than waiting for location data to be sent to the second computing device 104. In this manner, the second computing device 104 may exercise refined control over the exact times when location data is to be received. This may allow the second computing device 104 to only receive location data at certain times for verifying whether the user 112 is working, in view of a commuting pattern of the user 112, job duties of the user 112, the particular work schedule of the user 112, and location of the user 112 while working.

For example, the user 112 may be an office worker that works at an office location of an employer every Monday through Thursday, from 9 am to 5 pm. In view of this particular work location and work schedule for the user 112, the second computing device 104 may determine to request location data shortly after the user 112 is supposed to arrive at work (e.g., at 9:30 am) and shortly before the user 112 is supposed to leave from work (e.g., at 4:30 pm). This may allow the second computing device 104 to determine if the user 112 is showing up to work on time and staying for an entire work day, allowing the second computing device 104 to determine if the user 112 is employed and/or reliable.

In contrast, if the user 112 is a delivery driver that is expected to be driving around a certain geographical area while working, then the second computing device 104 may determine to request location data for the first computing device 102 more frequently and at regular intervals throughout a working day (e.g., at 9 am, 10 am, 11 am, 12 pm, 1 pm, 2 pm, and 3 pm). Overall, the second computing device 104 may request location data based on the type of job assigned to the user 112 and the expected location of the user 112 throughout a working day. Further, this allows the second computing device 104 to tailor receipt of location data to certain days and to certain times (e.g., at certain intervals). The second computing device 104 may also randomly request location data for the first computing device 102 and/or may adjust the times and/or intervals for requesting location data to reduce a likelihood of the user 112 being able to falsify or spoof his whereabouts.

Discussion will now turn to an example device that may be used to implement one or more aspects described herein.

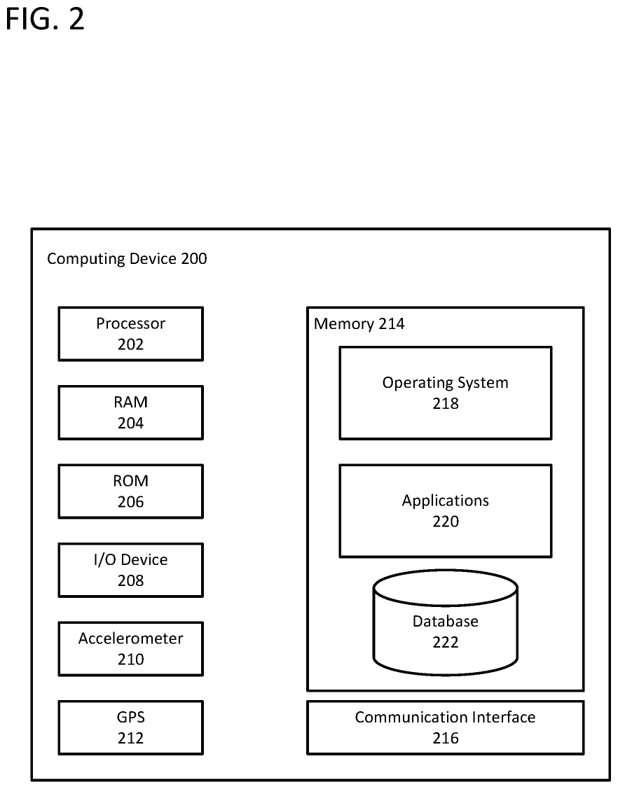

Any of the devices, components, and/or systems described herein may be implemented, in whole or in part, using one or more computing devices described with respect to FIG. 2. Turning now to FIG. 2, a computing device 200 that may be used with one or more of the computational systems is described. The computing device 200 may comprise one or more processors 202 for controlling overall operation of the computing device 200 and its associated components, including random access memory (RAM) 204, read-only memory (ROM) 206, input/output device 208, accelerometer 210, global-position system (GPS) antenna 212, memory 214, and/or communication interface 216. A bus (not shown in FIG. 2 for simplicity) may interconnect processor(s) 202, RAM 204, ROM 206, I/O device 208, accelerometer 210, global-position system receiver/antenna 212, memory 214, and/or communication interface 216. Computing device 200 may represent, be incorporated in, and/or comprise various devices such as a desktop computer, a computer server, a gateway, a mobile device, such as a laptop computer, a tablet computer, a smartphone, any other types of mobile computing devices, and the like, and/or any other type of data processing device.

Input/output (I/O) device 208 may comprise a microphone, keypad, touch screen, and/or stylus through which a user of the computing device 200 may provide input, and may also comprise one or more of a speaker for providing audio output and a video display device for providing textual, audiovisual, and/or graphical output. Software may be stored within memory 214 to provide instructions to processor 202 allowing computing device 200 to perform various actions. For example, memory 214 may store software used by the computing device 200, such as an operating system 218, application programs 220, and/or an associated internal database 222. The various hardware memory units in memory 214 may comprise volatile and nonvolatile, removable and non-removable media implemented in any method or technology for storage of information such as computer-readable instructions, data structures, program modules, or other data. Memory 214 may comprise one or more physical persistent memory devices and/or one or more non-persistent memory devices. Memory 214 may comprise RAM, ROM, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 202.

Accelerometer 210 may be a sensor configured to measure accelerating forces of computing device 200. Accelerometer 210 may be an electromechanical device. Accelerometer 210 may be used to measure the tilting motion and/or orientation computing device 200, movement of computing device 200, and/or vibrations of computing device 200. The acceleration forces may be transmitted to the processor 202 to process the acceleration forces and determine the state of computing device 200.

GPS receiver/antenna 212 may be configured to receive one or more signals from one or more global positioning satellites to determine a geographic location of computing device 200. The geographic location provided by GPS receiver/antenna 212 may be used for navigation, tracking, and positioning applications. In this regard, the geographic may also include places and routes frequented by the first user.

Communication interface 216 may comprise one or more transceivers, digital signal processors, and/or additional circuitry and software, protocol stack, and/or network stack for communicating via any network, wired or wireless, using any protocol as described herein.

Processor 202 may comprise a single central processing unit (CPU), which may be a single-core or multi-core processor, or may comprise multiple CPUs. Processor(s) 202 and associated components may allow the computing device 200 to execute a series of computer-readable instructions (e.g., instructions stored in RAM 204, ROM 206, memory 214, and/or in other memory of computing device 200) to perform some or all of the processes described herein. Although not shown in FIG. 2, various elements within memory 214 or other components in computing device 200, may comprise one or more caches, for example, CPU caches used by the processor 202, page caches used by the operating system 218, disk caches of a hard drive, and/or database caches used to cache content from database 222. A CPU cache may be used by one or more processors 202 to reduce memory latency and access time. A processor 202 may retrieve data from or write data to the CPU cache rather than reading/writing to memory 214, which may improve the speed of these operations. In some examples, a database cache may be created in which certain data from a database 222 is cached in a separate smaller database in a memory separate from the database 222, such as in RAM 204 or on a separate computing device. For example, in a multi-tiered application, a database cache on an application server may reduce data retrieval and data manipulation time by not needing to communicate over a network with a back-end database server. These types of caches and others may provide potential advantages in certain implementations of devices, systems, and methods described herein, such as faster response times and less dependence on network conditions when transmitting and receiving data.

Although various components of computing device 200 are described separately, functionality of the various components may be combined and/or performed by a single component and/or multiple computing devices in communication without departing from the disclosure.

Discussion will now turn to an example processing of an employment agreement.

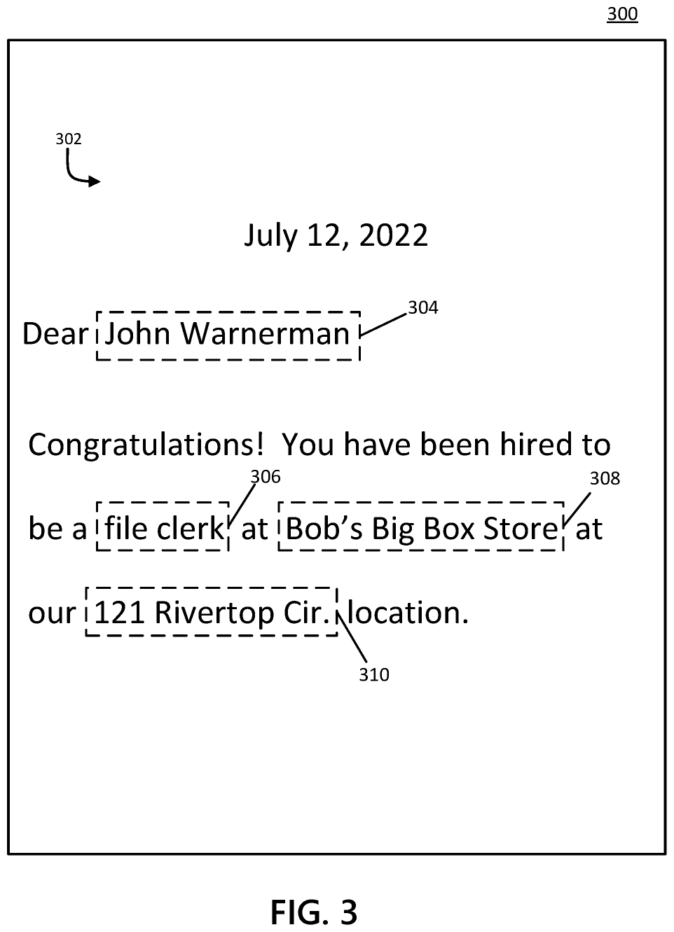

FIG. 3 illustrates an example employment agreement 300 that may be used to determine employment information for a user (e.g., the user 112) according to one or more aspects of the disclosure. The employment agreement 300 may be a document, file, or image provided to a computing device for processing. For example, the employment agreement 300 may be uploaded by a first computing device (e.g., the first computing device 102 or the third computing device 106) and sent to a second computing device (e.g., the second computing device 104). The second computing device may then process the received document, file, or image to determine information related to the employment of a user.

As shown in FIG. 3, the employment agreement 300 includes a body 302. A computing device may process the employment agreement 300 using one or more natural language processing techniques or algorithms and/or using one or more optical character recognition techniques or algorithms. By doing so, the computing device may be able to read and/or determine information provided on the employment agreement 300.

For example, processing the employment agreement 300 may allow the computing device to determine various details related to the employment of a user. In particular, processing the employment agreement 300 may allow the computing device to determine a name of the user 304 (e.g., John Warnerman), a job title of the user 306 (e.g., file clerk), a name of the employer 308 (e.g., Bob's Big Box Store), and a location of the employer 310 (e.g., 121 Rivertop Cir.). The body 302 of the employment agreement 300 may also provide an indication as to where the user will be expected to work. That is, the body 302 of the employment agreement 300 may be processed to determine that the user is expected work at the location of the employer 310 each working day. This employment information may then be used to further verify an employment of the user as described herein.

Discussion will now turn to example process for verifying employment of an individual.

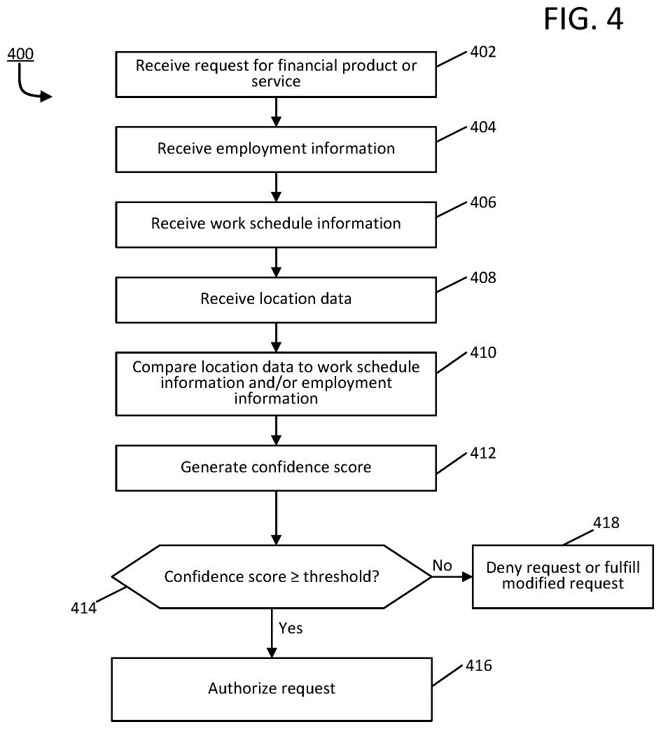

FIG. 4 shows a flow chart of a process 400 for determining whether to authorize a financial-related request based on verifying employment of a user according to one or more aspects of the disclosure. Some or all of the steps of process 400 may be performed using one or more computing devices (e.g., an application executing on a computing device) as described herein, including, for example, a client device, a server, or a memory and a processor configured to perform the methods described herein. For example, any portion of the process may be performed using the first computing device 102 of FIG. 1, the second computing device 104 of FIG. 1, the third computing device 106 of FIG. 1, the fourth computing device 108 of FIG. 1, or the computing device 200 of FIG. 2.

In step 402, a request may be received. The request may be received by a first computing device and may be sent by a second computing device. A user may cause the second computing device to send the request to the first computing device. The request may be a financially-related request. The request may be related to a financial account of the user. The request may be a request for a credit card, a request to increase a credit limit of a credit card, or a request for a loan. The request may identify the user and may indicate a value related to the request. The request may identify a particular financial product or service (e.g., a loan or a credit card).

In step 404, employment information or the user may be received. The employment information may be received by the first computing device. The user may cause the second computing device to send the employment information to the first computing device. The employment information may include data provided by the user. For example, the user may interact with the second computing device to enter data (e.g., via a touchscreen) related to the employment of the user. The user may enter data via an app and/or a Web-based portal. The employment information may include data provided by a document, file, or image. For example, the user may operate the second computing device to capture and/or store a document, image, or file that contains employment information related to the user and may cause the second computing device to transmit the document, image, or file to the first computing device (e.g., via upload using an app). All or a portion of the employment information may be provided by an employer of the user (e.g., via a computing device associated with the employer). The employment information may include any information related to employment of the user. For example, the employment information may include a name of the employer, a name of the user, a job title of the user, a job description of the user, a location of the employer, and/or an expectation of where the user will work for the employer (e.g., at home, at an office, out in the field, etc.).

Receiving employment information for the user may involve receiving a copy or an image of an employment agreement document for the user. A name of the employer, a job title of the user, and a location of the employer, along with any other information associated with the user's employment, may be determined based on processing the copy or image of the employment agreement document using one or more natural language processing algorithms. Computer visions algorithms may also be used to recognize company logos or other graphical features identifying an employer. For example, a user may receive an offer on letterhead from a company that identifies the company by a known logo and without any textual identification of the company. The letterhead may be processed to detect the logo and to associate it with the company. In this manner, an employer may be identified by recognizing a logo for the employer.

As part of receiving employment information for the user, the employment information received may be verified and/or validated. The first computing device may operate to verify certain employment information including the name of the employer, that the employer is an operating business, and a location of the employer.

The first computing device may collect public information associated with the employer. For example, the first computing device may use one more web crawler algorithms and/or may conduct a search of social media networks or posts to collect public information regarding the employer, including recent job postings or new hire information. The first computing device may validate the employer based on the public information associated with the employer and collected by the first computing device. A determination whether to authorize the request may be based on any validation of any information regarding the employer. Any information regarding the user's employment or employer may be verified or validated based on collection of public information.

In step 406, work schedule information for the user may be received. The work schedule information may be received by the first computing device. The user may cause the second computing device to send the work schedule information to the first computing device. The work schedule information may include data provided by the user. For example, the user may interact with the second computing device to enter data (e.g., via a touchscreen) related to the work schedule of the user. The user may enter work schedule information via an app and/or a Web-based portal. The work schedule information may include data provided by a document, file, or image. For example, the user may operate the second computing device to capture and/or store a document, image, or file that contains work schedule information related to the user and may cause the second computing device to transmit the document, image, or file to the first computing device (e.g., via upload using an app). All or a portion of the work schedule information may be provided by an employer of the user (e.g., via a computing device associated with the employer). The work schedule information may include any information related to work schedule of the user. For example, the work schedule information may indicate each day the user is scheduled to work for an employer and/or a timeframe the user is scheduled to work for the employer for each day the user is scheduled to work for the employer. As a particular example, work schedule information for a user may indicate that the user is to work for an employer each weekday from 9 am to 5 pm.

Receiving work schedule information for the user may involve receiving a copy or an image of work schedule document for the user. Each day the user is scheduled to work for the employer and the timeframe the user is scheduled to work for the employer for each day the user is scheduled to work for the employer may be determined based on processing the copy or image of the work schedule document for the user using one or more natural language processing algorithms. In this manner, the times each day the user is expected to work for the employer for each day of a week or other time period may be determined. Any document or work schedule information may also be processed based on one or more template-based algorithms. As many time sheets and work schedules include data formatted into a table or spreadsheet, one or more templated-based algorithms may be used determine any data or value indicated in a cell or block of any table of spreadsheet. A template based on the typical format and/or presentation of work schedule data for a particular employer may be generated and used by the templated-based algorithms.

In step 408, location data may be received. The location data may be received by the first computing device. The location data may be GPS data. The location data may be provided by a computing device associated with the user (e.g., a user computing device such as a smartphone). The location data may be provided by a computing device associated with a cellular servicer provider associated with a computing device associated with the user. The location data may be location data determined based on the computing device associated with the user connecting to one or more wireless networks (e.g., cellular wireless networks, Wi-Fi wireless networks, etc.). The user and/or the cellular service provider may authorize the sharing of the location data with the first computing device. The location data may be received at any time. The location data may be received periodically. The location data may be received response to a request issued by the first computing device for location data. The location data may be received continuously (including according to some periodicity) or may be received in batches (e.g., location data for an entire day or week for the user may be received at one time as opposed to sending current or real-time location data to the first computing device).

In various embodiments, the location data may be provided or otherwise accessible to the computing device associated with the user and/or may be provided or otherwise accessible to the computing device associated with the cellular service provided in an encoded form. For example, the location data may be GPS data encoded according to one or more techniques for encoding and/or formatting the GPS data. This encoded GPS location data may be provided to the computing device associated with the financial institution in its encoded form. The computing device associated with the financial institution may decode the encoded GPS data to a Degrees, Minutes, Seconds (DMS) format. As an example, the computing device associated with the user may receive raw GPS data signals and may directly provide the raw GPS data to the computing device associated with the financial institution. The computing device associated with the financial institution may then process the raw GPS data signals to generate GPS location data according to a desired format (e.g., DMS format).

Additionally, and/or alternatively, the GPS location data may be encrypted by the computing device associated with the user and/or to the computing device associated with the cellular service. The GPS location data may be encrypted to provide privacy for the user. The GPS data may be encrypted according to various encryption techniques, standards, and/or protocols including, for example, the Data Encryption Standard (DES), Triple DES, Advanced Encryption Standard (AES), and Rivest-Shamir-Adleman (RSA) protocol. The computing device associated with the user and/or to the computing device associated with the cellular service may provide the GPS location data to the computing device associated with the financial institution in an encrypted form. The computing device associated with the financial institution may decrypt the encrypted GPS location data to generate decrypted GPS location data that may be used to determine a location of the computing device associated with the user (and by proxy the location of the user).

In step 410, the location data may be compared to the work schedule information for the user. The first computing device may compare the location data to the work schedule information. The first computing data may compare the location data to the work schedule information as it is received or may compare the location data to the work schedule information at certain times (e.g., the first computing device may compare several hours of location data at a time to the work schedule information).

The work schedule information (and/or employment information) may be processed by the first computing device to determine an estimate of an expected location of the user for each day the user is to work for the employer. The first computing device may develop the estimate based on the type of job for the user, including a job description of the user. The first computing device may generate expected location information for the user for an entire time period the user is scheduled to work for the employer for each day the user works for the employer.

As an example, the user may be a software programmer that works from home. The first computing device may therefore expect the user to be located at home for most if not all of the user's workday. As such, the first computing device may compare the location data to the home address of the user to determine if the user is indeed at or near the user's house for most if not all of the user's workday. Location data of the computing device of the user may be received and processed throughout the day or location data of the computing device of the user may be received and processed at or near a start of the workday and at or near and end of a workday.

As another example, the user may be a construction worker that works at various construction sites. The first computing device may therefore expect the user to be located at one or more construction sites for most if not all of the user's workday. As such, the first computing device may compare the location data to the locations of various construction sites user to determine if the user is indeed at or near the construction sites for most if not all of the user's workday. Information regarding the locations of the construction sites may be provided by the user, by the user's employer, or may be determined by the first computing device conducting searches (e.g., based on one or more web crawler algorithms) to identify known construction sites of the user's employer.

An expected location of the user may account for the user's commute and commute travel time. The expected location of the user may account for locations where the user's computing device may not be able to determine or provide location data —such as, for example, if the user is located in an area not covered by a network, if the user is in a tunnel, etc.

In step 412, a confidence score or rating for the user may be generated. The confidence score may indicate a likelihood that the user works for the employer (i.e., a likelihood that the user actually works for the employer and is not falsely alleging employment with the employer). The confidence score may indicate a measure of a reliability of the user. That is, the confidence score may indicate if the user is reliably showing up to work on time, working all day, and then leaving work on time (e.g., not leaving work early). The confidence score may therefore indicate a financial risk associated with the user as that risk may pertain to the user's employment and reliability to retain the employment. The confidence score may indicate and/or be a proxy for estimating or determining a creditworthiness of the user.

The confidence score may be generated by the first computing device. The confidence score may be generated based on comparing the location data to the work schedule information for the user. The confidence score may be generated based on comparing the location data to the work schedule information for the user over a predetermined period of time. The period of time may be any period of time such as, for example, a day, a week, two weeks, or a month. The confidence score may be generated at particular intervals of time and may be adjusted at the end of a next interval of time based on an analysis or comparison of the location data to the work schedule information for the user during the next interval of time. The user may provide updated work schedule information (and/or updated employment information) that may be used to adjust an expectation of when and where the user should be working for the employer.

The first computing device may adjust (e.g., increase or decrease) the confidence score over time as new or current location data for the user is obtained and compared to new or current work schedule information for the user. As an example, the first computing device may use the location data and work schedule information to determine each instance when the location data indicates that the user was located at the location of the employer (and/or the expected work location of the user) during the timeframe the user is scheduled to work for the employer, for each day the user is scheduled to work for the employer. In other words, the first computing device may determine each instance when location data indicates the user was located at a location associated with the user's employment with the employer (e.g., the user was at home during normal working hours and the user is a remote work-from-home worker for the employer). The first computing device may increase the confidence score of the user for each such determined instance.

As another example, the first computing device may use the location data and work schedule information to determine each instance when the location data indicates that the user was not located at the location of the employer (and/or the expected work location of the user) during the timeframe the user is scheduled to work for the employer, for each day the user is scheduled to work for the employer. In other words, the first computing device may determine each instance when location data indicates the user was not located at a location associated with the user's employment with the employer (e.g., the user was not at the office during normal working hours and the user is expected to be at the office each working day for the employer). The first computing device may decrease the confidence score of the user for each such determined instance.

In step 414, a determination may be made as to whether the confidence score meets or exceeds a predetermined threshold (e.g., a confidence score threshold). The determination may be made by the first computing device. The threshold may be generated based on the request and/or based on employment information of the user. For example, the threshold may be set to be relatively higher (e.g., 75) if the user is requesting a relatively large loan (e.g., a loan of over $10,000.00), if the user has no prior work history, and if the user is being paid by the employer at a relatively lower rate (e.g., $10.00 per hour). The threshold may be set to be relatively lower (e.g., 25) if the user is requesting a relatively small loan (e.g., a loan of less than $1,000.00), if the user has a prior work history, and if the user is being paid by the employer at a relatively higher rate (e.g., $20.00 per hour). The threshold may be expressed in any units and according to any scale. As an example, the threshold may be set to be an integer between 1 and 100, inclusively.

Machine learning (ML) models, techniques, or algorithms may be used to set or adjust the predetermined threshold. A ML model may be trained on data that may include data related to other users such as job information and request information, including whether a request for a user was approved or denied. Based on one or more such ML models, an estimate for the predetermined threshold may be determined. For example, the ML model may determine from training data related to prior users that a predetermined threshold should be set to a certain value for a certain type of work and a certain type of request.

Process 400 may proceed to step 416 if it is determined that the generated confidence score meets or exceeds the predetermined threshold. The determination may be made by the first computing device. At step 416, the request may be authorized and/or otherwise fulfilled. The decision to authorize the request may be made by the first computing device. As an example, if the request is for the user to obtain a credit card with a $5,000.00 limit, then the first computing device may generate one or more outputs indicating that the request may be approved and fulfilled. The first computing device may cause the financial institution associated with the first computing device to create and issue a credit card for the user according to the request.

Process 400 may proceed to step 418 if it is determined that the generated confidence score does not meet or exceed the predetermined threshold. The determination may be made by the first computing device. At step 418, the request may not be authorized. The decision to not authorize the request may be made by the first computing device. As an example, if the request is for the user to obtain a credit card with a $10,000.00 limit, then the first computing device may generate one or more outputs indicating that the request may not be approved and fulfilled.

Alternatively, or in addition thereto, an alternative (or modified) request may be authorized and/or otherwise fulfilled. For example, the generated confidence score may not meet or exceed the predetermined threshold but may be relatively close to the threshold (e.g., the generated confidence score may indicate a value of 70 and the predetermined threshold may indicate a value of 75). An original or initial request for the user to obtain a credit card with a $10,000.00 limit may be denied; however, the first computing device may determine that a credit card with a $5,000.00 limit may be granted. As such, the first computing device may generate one or more outputs indicating that the original request is not be authorized while also indicating that an alternative request may be authorized. The first computing device may provide a notification to a computing device operated by the user indicating that the original request was denies but that the alternative request is approvable. The user may then provide a response to the notification indicating whether or not the user would like for the alternative request to be fulfilled or not (e.g., the user may provide a response that indicates that the user will settle for a credit card having a credit limit of $5,000.00 as opposed to the original request for a credit limit of $10,000.00).

The steps of process 400 may be implemented in any order and are not limited to being implemented in the order show or as discussed herein. The steps of process 400 may also be combined.

Techniques described herein for employment verification enable a user or individual to obtain authorization of a financial request without a credit history in an efficient and convenient manner. A user may receive access to a financial product or service more quickly based on the techniques described herein without facing cumbersome requirements (e.g., detailed in-person interviews, requirements for detailed personal or family information, and/or providing multiple paychecks). As a result, a user's experience in obtaining financial assistance in some manner is made more accessible. Additionally, a financial institution may accurately and reliably determine a financial risk associated with a user without the benefit of a credit history for the user. The techniques described herein allow the financial institution to efficiently assess whether the user is employed and/or reliable and therefore likely to remain employed. In turn, the user's creditworthiness may be assessed to determine if a financial request of the user should be granted.

One or more features discussed herein may be embodied in computer-usable or readable data and/or computer-executable instructions, such as in one or more program modules, executed by one or more computers or other devices as described herein. Program modules may comprise routines, programs, objects, components, data structures, and the like. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. The functionality of the program modules may be combined or distributed as desired. In addition, the functionality may be embodied in whole or in part in firmware or hardware equivalents such as integrated circuits, field programmable gate arrays (FPGA), and the like. Particular data structures may be used to more effectively implement one or more features discussed herein, and such data structures are contemplated within the scope of computer executable instructions and computer-usable data described herein. Various features described herein may be embodied as a method, a computing device, a system, and/or a computer program product.

Although the present disclosure has been described in terms of various examples, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present disclosure may be practiced otherwise than specifically described without departing from the scope and spirit of the present disclosure. Although examples are described above, features and/or steps of those examples may be combined, divided, omitted, rearranged, revised, and/or augmented in any desired manner. Thus, the present disclosure should be considered in all respects as illustrative and not restrictive. Accordingly, the scope of the disclosure should be determined not by the examples, but by the appended claims and their equivalents.

What is claimed is:

1. A method comprising:
receiving, at a first computing device, a request associated with an account associated with a user;
receiving, at the first computing device, employment information for the user, wherein the employment information comprises:
a name of an employer;
a job title of the user; and
a location of the employer;
receiving, at the first computing device, work schedule information, for the user, that indicates:
each day the user is scheduled to work for the employer; and
a timeframe the user is scheduled to work for the employer for each day the user is scheduled to work for the employer;
receiving, at the first computing device and from a user computing device associated with the user, location data that indicates a current location of the user;
decrypting, by the first computing device, the location data to generate decrypted location data;
comparing, by the first computing device, the decrypted location data to the work schedule information for the user;
generating, by the first computing device and based on comparing the decrypted location data to the work schedule information for the user, a confidence score, for the user, that indicates a likelihood the user is employed by the employer;
comparing, by the first computing device, the confidence score for the user to a predetermined threshold; and
determining, by the first computing device and based on the confidence score of the user meeting or exceeding the predetermined threshold, to authorize the request associated with the account associated with the user.

2. The method of claim 1, wherein the location data comprises Global Positioning System (GPS) data.

3. The method of claim 1, wherein receiving the employment information for the user further comprises:
receiving a copy of an employment agreement for the user; and
determining the name of the employer, the job title of the user, and the location of the employer based on processing the copy of the employment agreement using one or more natural language processing algorithms.

4. The method of claim 1, further comprising:
collecting, by the first computing device and based one or more web crawler algorithms, public information associated with the employer; and
validating, by the first computing device, the employer based on the public information associated with the employer, wherein determining to authorize the request is based on the validating.

5. The method of claim 1, wherein receiving the work schedule information for the user further comprises:
receiving a copy of a work schedule for the user; and
determining each day the user is scheduled to work for the employer and the timeframe the user is scheduled to work for the employer for each day the user is scheduled to work for the employer based on processing the copy of the work schedule for the user using one or more natural language processing algorithms.

6. The method of claim 1, wherein the account comprises a loan and the request comprises an amount for the loan.

7. The method of claim 1, wherein the account comprises a credit card and the request comprises a credit limit for the credit card.

8. The method of claim 1, further comprising:
determining, by the first computing device, and based on the decrypted location data and based on the work schedule information, that the user works from home, wherein determining to authorize the request is based on the determining that the user works from home.

9. The method of claim 1, further comprising:
determining, by the first computing device, and based on the decrypted location data and based on the work schedule information, that the user drives a delivery vehicle, wherein determining to authorize the request is based on the determining that the user drives the delivery vehicle.

10. The method of claim 1, further comprising:
determining, by the first computing device, each instance when the decrypted location data indicates that the user was located at the location of the employer during the timeframe the user is scheduled to work for the employer, for each day the user is scheduled to work for the employer; and
increasing the confidence score of the user for each determined instance.

11. The method of claim 1, further comprising:
determining, by the first computing device, each instance when the decrypted location data indicates that the user was not located at the location of the employer during the timeframe the user is scheduled to work for the employer, for each day the user is scheduled to work for the employer; and
decreasing the confidence score of the user for each determined instance.

12. The method of claim 1, further comprising determining, by the first computing device, the predetermined threshold based on an estimated values associated with the request.

13. The method of claim 1, further comprising determining, by the first computing device, the predetermined threshold based on the request associated with the account and based on a type of the account.

14. The method of claim 1, further comprising:
collecting, by the first computing device and based on searching a social network platform, public information associated with the employer; and
validating, by the first computing device, the employer based on the public information associated with the employer, wherein determining to authorize the request is based on the validating.

15. An apparatus, comprising:
one or more processors; and
memory storing instructions that, when executed by the one or more processors, cause the apparatus to:
receive a request for a financial product, the request associated with a user;
receive employment information for the user, wherein the employment information comprises:
a name of an employer;
a job title of the user; and
an expected work location for the user;
receive work schedule information, for the user, that indicates:
each day the user is scheduled to work for the employer; and
a timeframe the user is scheduled to work for the employer for each day the user is scheduled to work for the employer;
receive, from a user computing device associated with the user, location data that indicates a current location of the user;
decrypting the location data to generate decrypted location data;
compare the decrypted location data to the work schedule information for the user;
generate, based on comparing the decrypted location data to the work schedule information for the user and the expected work location for the user, a confidence score, for the user, that indicates a likelihood the user is employed by the employer;
compare the confidence score for the user to a predetermined threshold; and
determine, based on the confidence score of the user meeting or exceeding the predetermined threshold, to authorize the request associated with the account associated with the user.

16. The apparatus of claim 15, the memory storing instructions that, when executed by the one or more processors, cause the apparatus to:
receive a copy of an employment agreement for the user; and
determine the name of the employer, the job title of the user, and the location of the employer based on processing the copy of the employment agreement using one or more natural language processing algorithms.

17. The apparatus of claim 15, the memory storing instructions that, when executed by the one or more processors, cause the apparatus to:
collect, by the first computing device and based on one or more web crawler algorithms, public information associated with the employer; and
validating, by the first computing device, the employer based on the public information associated with the employer, wherein determining to authorize the request is based on the validating.

18. The apparatus of claim 15, the memory storing instructions that, when executed by the one or more processors, cause the apparatus to:
receive a copy of a work schedule for the user; and
determine each day the user is scheduled to work for the employer and the timeframe the user is scheduled to work for the employer for each day the user is scheduled to work for the employer based on processing the copy of the work schedule for the user using one or more natural language processing algorithms.

19. The apparatus of claim 15, the memory storing instructions that, when executed by the one or more processors, cause the apparatus to:
determine, based on the decrypted location data and the work schedule information, that the user is at least one of an employee that works at the employer location, an employee that works from home for the employer, or an employee that is a delivery driver for the employer.

20. One or more non-transitory media storing instructions that, when executed by one or more processors, cause the one or more processors to perform steps comprising:
receive a request associated with an account associated with a user;
receive employment information for the user, wherein the employment information comprises:
a name of an employer;
a job title of the user; and
a location of the employer;
receive work schedule information, for the user, that indicates:
each day the user is scheduled to work for the employer; and
a timeframe the user is scheduled to work for the employer for each day the user is scheduled to work for the employer;
receive, from a user computing device associated with the user, location data that indicates a current location of the user;
compare the location data to the work schedule information for the user;
generate, based on comparing the location data to the work schedule information for the user, a confidence score, for the user, that indicates a likelihood the user is employed by the employer;
compare the confidence score for the user to a predetermined threshold; and
determine, based on the confidence score of the user meeting or exceeding the predetermined threshold, to authorize the request associated with the account associated with the user.
